(19) United States
(12) Patent Application Publication
(10) Pub. No.: US 2024/0409733 A1
(43) Pub. Date: Dec. 12, 2024

(54) A RECYCLABLE THERMOPLASTIC COMPOSITION

(71) Applicant: UPM-Kymmene Corporation, Helsinki (FI)

(72) Inventors: Barbara GALL, Helsinki (FI); Florian DIEHL, Helsinki (FI)

(21) Appl. No.: 18/702,755

(22) PCT Filed: Oct. 21, 2021
(86) PCT No.: PCT/FI2021/050704

§ 371 Date: Apr. 18, 2024

(51) Int. Cl. C08L 23/12; C08J 3/22; C08K 3/04; C08L 55/02

(52) U.S. Cl. CPC C08L 23/12; C08J 3/226; C08K 3/04; C08L 55/02; C08J 2323/12; C08J 2325/06; C08L 2205/025; C08L 2310/00

(57) ABSTRACT

A recyclable thermoplastic composition made by using at least one polymer and a lignin-based filler is disclosed. Further, is disclosed the use of a lignin-based filler for producing a recyclable thermoplastic composition and a method for producing a recyclable thermoplastic composition. Further is disclosed an article and the use of the thermoplastic composition.

### TECHNICAL FIELD

The present disclosure relates to a recyclable thermoplastic composition. The present disclosure further relates to the use of a lignin-based filler. The present disclosure further relates to a method for producing a recyclable thermoplastic composition. The present disclosure further relates to an article and to the use of the thermoplastic composition.

### BACKGROUND

In the light of sustainability and circular it economy is desired to recycle thermoplastic compositions or materials, such as packaging materials, in a closed loop. Carbon black is commonly used as the pigment or filler in black colored plastics. Sustainability of the components of plastic production is of importance and there is a need for biobased and renewable components in the plastics. Therefore, the inventors have recognized a need for renewable black coloring fillers or pigments, which allow sorting of the polymers in the composition and thus enable recycling of the thermoplastic composition.

### SUMMARY

A recyclable thermoplastic composition made by using at least one polymer and a lignin-based filler is disclosed. The lignin-based filler may be prepared from lignin subjected to hydrothermal carbonization treatment. The lignin-based filler may comprise carbon in a total amount of 62-70 weight-% and ash in a total amount of at most 3 weight-%, and
the color of the thermoplastic composition may be represented by an L value of at most 25, an a value of at most 8, and a b value of at most 12 as determined by DIN EN ISO 11664.

Further is disclosed the use of a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%, for producing a recyclable thermoplastic composition by using at least one polymer and the lignin-based filler, wherein:
the color of the thermoplastic composition is represented by an L value of at most 25, an a value of at most 8, and a b value of at most 12 as determined by DIN EN ISO 11664.

Further is disclosed a method for producing a recyclable thermoplastic composition comprising at least one polymer and a lignin-based filler, wherein the method comprises:
providing at least one polymer and a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%; and
combining the at least one polymer and the lignin-based filler to form the recyclable thermoplastic composition, wherein the color of the thermoplastic composition is represented by an L value of at most 25, an a value of at most 8, and a b value of at most 12 as determined by DIN EN ISO 11664.

Further is disclosed an article comprising the thermoplastic composition as defined in the current specification.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, an electrical component, an electronic component, a part for energy generation, a toy, an appliance, a kitchenware, a tableware, a flooring, a fabric, a medical application, a food contact material, a construction material, a drinking water application, and/or a furniture.

### DETAILED DESCRIPTION

A recyclable thermoplastic composition made by using at least one polymer and a lignin-based filler is disclosed. The lignin-based filler may be prepared from lignin subjected to hydrothermal carbonization treatment. The lignin-based filler may comprise carbon in a total amount of 62-70 weight-% and ash in a total amount of at most 3 weight-8, and
the color of the thermoplastic composition is represented by an L value of at most 25, an a value of at most 8, and a b value of at most 12 as determined by DIN EN ISO 11664.

Further is disclosed the use of a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%, for producing a recyclable thermoplastic composition by using at least one polymer and the lignin-based filler, wherein:
the color of the thermoplastic composition is represented by an L value of at most 25, an a value of at most 8, and a b value of at most 12 as determined by DIN EN ISO 11664.

Further is disclosed a method for producing a recyclable thermoplastic composition comprising at least one polymer and a lignin-based filler, wherein the method comprises:
providing at least one polymer and a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%; and
combining the at least one polymer and the lignin-based filler form to the recyclable thermoplastic composition, wherein the color of the thermoplastic composition is represented by an L value of at most 25, an a value of at most 8, and a b value of at most 12 as determined by DIN EN ISO 11664.

Further is disclosed an article comprising the thermoplastic composition as defined in the current specification. In one embodiment, thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

Further is disclosed the use of the thermoplastic composition as defined in the current specification in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.

A thermoplastic composition, or thermosoftening plastic composition as it may also be called, is a plastic polymer material that becomes pliable or moldable at a certain elevated temperature and solidifies upon cooling.

The thermoplastic composition may be prepared by using at least one polymer and a lignin-based filler. Further components or materials, such as additives, lubricants, stabilizers, antioxidants, other fillers etc., may also be used for preparing the thermoplastic composition. In one embodiment, the step of combining the at least one polymer and the lignin-based filler comprises also combining one or more additives, lubricants, stabilizers, and/or antioxidants to form the recyclable thermoplastic composition.

In one embodiment, combining the at least one polymer and lignin-based the filler comprises preparing a masterbatch and then compounding the masterbatch with the at least one polymer. In one embodiment, combining the at least one polymer and the lignin-based filler comprises preparing a masterbatch and subsequently compounding the masterbatch with either the same or a different polymer and optionally further additives. In one embodiment, combining the at least one polymer and the lignin-based filler comprises directly compounding the polymer and the lignin-based filler.

When preparing the recyclable thermoplastic composition a so-called masterbatch may first be prepared by using polymer and the lignin-based filler. The masterbatch may be prepared by mixing the polymer and the lignin-based at filler an elevated temperature. Also other additives, lubricants, stabilizer, antioxidants, other fillers, etc. as needed may be included in the masterbatch. A masterbatch is generally considered a solid product (normally of plastic, rubber, or elastomer) in which pigments or fillers are optimally dispersed at high concentration in a carrier material. The carrier material is compatible with the main plastic in which it will be blended during molding, whereby the final plastic product, i.e. the thermoplastic composition, obtains the color or properties from the masterbatch.

Alternatively, the thermoplastic composition is directly compounded at an elevated temperature from the polymer and the lignin-based filler. Also other additives, lubricants, stabilizers, antioxidants, other fillers, etc. as needed may be directly compounded with the polymer and the lignin-based filler.

The temperature used when combining the at least one polymer and the lignin based filler may vary depending on the type of polymer used. The suitable temperature to be used for each polymer is readily available to the person skilled in the art. Also the polymer providers suitable processing define temperatures for different polymers. Generally, temperatures of e.g. 150-440° C., or 180-350° C., or 200-300° C., may be used.

The thermoplastic composition contains 0.1-65 weight-%, or 0.3-60 weight-%, or 0.5-50 weight-%, or 1-40 weight-%, or 1.2-30 weight-%, or 1.5-20 weight-%, or 2-10 weight-%, or 2.5-5 weight-%, of the lignin-based filler based on the total weight of the thermoplastic composition. In one embodiment, the thermoplastic composition may contain 0.1-10 weight-%, or 0.1-5 weight-%, of the lignin-based filler based on the total weight of the thermoplastic composition.

The “total weight” should this in specification be understood, unless otherwise stated, as the weight of all the components of the thermoplastic composition including possible moisture.

The thermoplastic composition may comprise at least one polymer, e.g. at least two different polymers, at least three different polymers, at least four different polymers etc. The polymer may be any polymer selected from the group of thermoplastic polymers or a combination of different thermoplastic polymers. The polymer may be selected from one or more of the following: polyethylene, polypropylene, polystyrene, ethylene-vinyl acetate (EVA), polybutylene adipate terephthalate (PBAT), polyamide, polyacrylate, polyester, acrylonitrile butadiene styrene (ABS), polycarbonate, polylactic acid (PLA), polyvinyl chloride (PVC) etc. In one embodiment, the thermoplastic composition comprises polyethylene, polypropylene, and/or acrylonitrile butadiene styrene. I.e. one type of polymer may be used for producing the recyclable thermoplastic composition or a combination of two or more different polymers may be used.

By the expression “lignin-based filler” should be understood in this specification, unless otherwise stated, as referring to a filler that has been prepared from lignin subjected to hydrothermal carbonization treatment (HTC).

The hydrothermal carbonization treatment of lignin refers to a thermochemical conversion process of lignin-containing material in an aqueous suspension. Hydrothermal carbonization treatment of lignin produces lignin derivatives having high carbon content and functional groups.

Lignin is a biopolymer, that is a key structural material in the supporting tissues of most living plants. It is a renewable material which can be used in several applications.

The lignin used for preparing the lignin-based filler may be selected from a group consisting of kraft lignin, steam explosion lignin, biorefinery lignin, supercritical separation lignin, hydrolysis lignin, flash precipitated lignin, biomass originating lignin, lignin from alkaline pulping process, lignin from soda process, lignin from organosolv pulping, lignin from alkali process, lignin from enzymatic hydrolysis process, and any combination thereof. In one embodiment, the lignin is wood based lignin. The lignin can originate from softwood, hardwood, annual plants or from any combination thereof.

By “kraft lignin” is to be understood in this specification, unless otherwise stated, lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different, techniques including e.g. precipitation and filtration. Lignin usually begins precipitating at pH values below 11-12. Different pH values can be used in order to precipitate lignin fractions with different properties. These lignin fractions differ from each other by molecular weight distribution, e.g. Mw and Mn, polydispersity, hemicellulose and extractive contents. The molar mass of lignin precipitated at a higher pH value is higher than the molar mass of lignin precipitated at a lower pH value. Further, the molecular weight distribution of lignin fraction precipitated at a lower pH value is wider than of lignin fraction precipitated at a higher pH value. The precipitated lignin can be purified from inorganic impurities, hemicellulose and wood extractives using acidic washing steps. Further purification can be achieved by filtration.

The term “flash precipitated lignin” should be understood in this specification as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The method for producing flash precipitated lignin is disclosed in patent application FI 20106073. The residence time in the above method is under 300 s. The flash precipitated lignin particles, having a particle diameter of less than 2 μm, form agglomerates, which can be separated from black liquor using e.g. filtration. The advantage of the flash precipitated lignin is its higher reactivity compared to normal kraft lignin. The flash precipitated lignin can be purified and/or activated if needed for the further processing.

The lignin may be derived from an alkali process. The alkali process can begin with liquidizing alkali followed by a biomass with strong neutralization process. After the alkali treatment, the lignin can be precipitated in a similar manner as presented above.

The lignin may be derived from steam explosion. Steam explosion is a pulping and extraction technique that can be applied to wood and other fibrous organic material.

By “biorefinery lignin” is to be understood in this specification, unless otherwise stated, lignin that can be recovered from a refining facility or process where biomass is converted into fuel, chemicals and other materials.

By “supercritical separation lignin” is to be understood in this specification, unless otherwise stated, lignin that can be recovered from biomass using supercritical fluid separation or extraction technique. Supercritical conditions correspond to the temperature and pressure above the critical point for a given substance. In supercritical conditions, distinct liquid and gas phases do not exist. Supercritical water or liquid extraction is a method of decomposing and converting biomass into cellulosic sugar by employing water or liquid under supercritical conditions. The water or liquid, acting as a solvent, extracts sugars from cellulose plant matter and lignin remains as a solid particle.

The lignin may be derived from a hydrolysis process. The lignin derived from the hydrolysis process can be recovered from paper-pulp or wood-chemical processes.

The lignin may originate from an organosolv process. Organosolv is a pulping technique that uses an organic solvent to solubilize lignin and hemicellulose.

In one embodiment, the lignin-based filler is prepared from lignin derived from enzymatic hydrolysis process and/or from a Kraft process and subjected to the hydrothermal carbonization treatment. In one embodiment, the lignin-based filler is prepared from lignin derived from enzymatic hydrolysis process and subjected to the hydrothermal carbonization treatment. In one embodiment, the lignin-based filler is prepared from lignin derived from a Kraft process and subjected to the hydrothermal carbonization treatment.

In one embodiment, the enzymatic hydrolysis process comprises enzymatic hydrolysis of a plant-based feedstock, such as a wood-based feedstock. In one embodiment, the enzymatic hydrolysis process comprises enzymatic hydrolysis of cellulose. In one embodiment, the lignin-based filler is prepared from lignin derived from pulping of wood, e.g. Kraft lignin.

The lignin-based filler as disclosed in the current specification may be prepared as disclosed below. The lignin to be used may be derived from e.g. a process wherein the lignin is formed in enzymatic hydrolysis of lignocellulosic feedstock or the lignin may be derived from a Kraft process. Also other lignin sources may be used.

The derived lignin may be dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The dissolved lignin may then be subjected to hydrothermal carbonization treatment (HTC).

The hydrothermal carbonization treatment may take place in a reactor (HTC reactor), or if needed, in several parallel reactors, working in a batchwise manner. The dissolved lignin may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprising the carbonized lignin may then be removed and cooled.

Consequently, a slurry comprising lignin-based filler is formed.

The slurry comprising lignin-based filler may be fed to a separation unit, wherein the precipitated lignin may be separated from the slurry. The separated lignin-based filler may be dried and recovered. Before drying, the lignin-based filler may be, if needed, washed. The recovered lignin-based filler may be treated further, e.g. crushed, dried further, milled etc. before using as the lignin-based filler. The thus formed lignin-based filler is a renewable and a biobased filler.

During the above described process lignin polymers connected to each other. Thus, the lignin-based filler may be considered to comprise or consist of lignin polymers that are linked together. Lignin polymers that are connected or linked together may not be soluble anymore. However, smaller lignin polymer chains still remain soluble and thus can be subjected to standard analytical techniques like size exclusion chromatography or nuclear magnetic resonance spectroscopy (NMR spectroscopy), which require the analyte to be dissolved in a solvent. Thus, different properties of the soluble fraction of the lignin-based filler may be determined.

In one embodiment, the starting material for preparing the lignin-based filler is lignin taken from enzymatic hydrolysis process. Enzymatic hydrolysis is a process, wherein enzyme(s) assist(s) in cleaving bonds in molecules with the addition of elements of water. In one embodiment, the enzymatic hydrolysis comprises enzymatic hydrolysis of cellulose.

In one embodiment, the lignin-based filler is prepared from lignin derived from enzymatic hydrolysis process that is subjected to hydrothermal carbonization treatment.

In one embodiment, the lignin-based filler comprises ash in a total amount of 0.1-3 weight-%, or 0.1-2.5 weight-%, or 0.2-2.0 weight-%, or 0.3-1.5 weight-%, or 0.4-1.0 weight-%. The ash content can be determined according to the standard DIN 51719.

The inventors surprisingly found out that when e.g. lignin from enzymatic hydrolysis process is used for producing the lignin-based filler, one is able to lower the ash content of the lignin-based filler. The lower ash content has the added utility of e.g. higher purity of the lignin-based filler.

The lignin-based filler may comprise carbon in a total amount of 62-70 weight-%. In one embodiment, the lignin-based filler comprises carbon in a total amount of 63-69 weight-%, or 64-68 weight-%. The amount of carbon in the lignin-based filler may be determined according to standard DIN 51732 (1997).

In one embodiment, the solubility of the lignin-based filler in 0.1 M NaOH is 1-40 weight-%, or 3-35 weight-%, or 5-30 weight-%. The solubility may be measured in the following manner: First a sample is dried at a temperature of 60° C. for four hours. A sample mass of 0.5 gram is weighed and suspended in 50 ml of 0.1 M NaOH at a concentration of 1% having a temperature of 22° C. Mixing is continued for 1 hour, where after the sample is placed on a glass microfiber paper (1.6 μm) and the filter paper with the sample is dried at a temperature of 60° C. for 2 hours. The portion of the sample has which has dissolved can be determined gravimetrically.

In one embodiment, the lignin-based filler has a weight average molecular weight (Mw) of 1000-4000 Da, or 1300-3700 Da, or 1700-3200 Da, or 2500-3000 Da, or 2600-2900 Da, or 2650-2850 Da, when determined based on the soluble fraction of the lignin-based filler. The weight average molecular weight may be determined with size exclusion chromatography (SEC) by using 0.1 M NaOH as eluent and a sample amount of about 1 mg/ml, which is dissolved in 0.1 M NaOH. The molecular weights are measured against polystyrenesulfonate standards. UV detector at wavelength of 280 nm is used.

The polydispersity index (PDI) of the lignin-based filler may be 1.5-5.0, or 1.8-4.5, or 1.9-4.3, or 2.1-4.0, or 2.4-3.5, or 2.6-3.2, when determined based on the soluble fraction of the lignin-based filler. The polydispersity index may be determined by size-exclusion chromatography (SEC). The PDI is a measure of the distribution of molecular mass in a given polymer sample. The PDI is calculated as the weight average molecular weight (Mw) divided by the number average molecular weight (Mn). PDI indicates the distribution of individual molecular masses in a batch of polymers.

The lignin-based filler may have a STSA number of 3-150 m²/g, or 5-100 m²/g, or 7-60 m²/g. The STSA number may be determined according to standard ASTM D6556.

In one embodiment, the lignin-based filler has a density of at most 1.5 g/cm³. In one embodiment, the lignin-based filler has a density of 1.0-1.5 g/cm³, or 1.15-1.35 g/cm³, or 1.1-1.4 g/cm³. The density may be determined according to standard ISO 21687.

By the expression “recycling process” should be understood in this specification, unless otherwise stated, as referring to a process by which the ability of the thermoplastic composition to be recycled is tested. The thermoplastic composition when being prepared by using the at least one polymer and the lignin-based filler, and possible additional materials, may be compounded with an extruder. By the expression “recycling process” is meant in the current specification a process comprising subjecting the prepared thermoplastic composition to an additional extrusion cycle or extrusion loop. I.e. the recyclability of the thermoplastic composition is tested by subjecting the thermoplastic composition to additional extrusion. An examples of an extruder that may be used is Leistritz ZSE 27 MAXX, which is a high speed co-rotating twin screw extruder with a screw diameter of 27 mm and a L/D of 48. When referring to the recycling process, it is to be understood that the thermoplastic composition is subjected to one or more additional extrusion cycles or extrusion loops.

The melt flow index (MFI) may be determined according to ISO 1133-1:2012 (Plastics-Determination of the melt mass-flow rate (MFR) and melt volume flow rate (MVR) 4 thermoplastics Part 1: Standard method). The melt flow index may be taken as an indication of 41 the flowability, and thus the processability, of the thermoplastic composition. The higher the melt flow index, the lower is the viscosity of the thermoplastic composition.

In one embodiment, the melt flow index of the thermoplastic composition, after having subjected the thermoplastic composition to a recycling process as described in the description, differs at most 15 percent, or at most by 10 percent, or at most by 5 percent, from the melt flow index of the same thermoplastic composition before having been subjected to the recycling process.

In one embodiment, the melt flow index of the thermoplastic composition, after having subjected the thermoplastic composition to a recycling process as described in the description, is at most 15 percent, or at most 10 percent, or at most 5 percent, higher or lower than the melt flow index of the same thermoplastic composition before having been subjected to the recycling process.

In one embodiment, the melt flow index of the thermoplastic composition, after having subjected the thermoplastic composition nine times to the recycling process as described in the description, differs at most by 15 percent, or at most by 10 percent, or at most by 5 percent, from the melt flow index of the same thermoplastic composition before having been subjected to the recycling process.

In one embodiment, the melt flow index of the thermoplastic composition, after having subjected the thermoplastic composition nine times to the recycling process as described in the description, is at most 15 percent, or at most 10 percent, or at most 5 percent, higher or lower than the melt flow index of the same thermoplastic composition before having been subjected to the recycling process.

The inventors surprisingly found out that the melt flow index of the thermoplastic composition does not essentially change, e.g. increase or decrease, during the recycling process(es). Thus, as the melt flow index of the thermoplastic composition is not essentially changing, e.g. increasing, as a result of subjecting the same to one or more recycling processes it may be concluded that the polymer in the thermoplastic composition is not degraded or destroyed during recycling. The thermoplastic composition as defined in the current specification thus shows a good stability.

The oxidation induction time (OIT) is a measurement of the resistance of a material to oxidative decomposition. To achieve this, a sample may be heated at a constant rate in an inert atmosphere, when reaching the set temperature (ideally the processing temperature) the gas flow is switched to air atmosphere. From this point the temperature is held constant until an oxidative reaction is detected through a exothermal deviation in the differential scanning calorimetry (DSC) curve. The time interval between the start of oxygen air flow and oxidative reaction is the OIT. The temperature used depends on the polymer that is being analyzed.

In one embodiment, the oxidation induction time of the thermoplastic composition, after having subjected the thermoplastic composition to a recycling process as described in the description, differs at most 15 percent, or at most by 10 percent, from the oxidation induction time of the same thermoplastic composition before having been subjected to the recycling process.

In one embodiment, the oxidation induction time of the thermoplastic composition, after having subjected the thermoplastic composition to a recycling process as described in the description, is at most 15 percent, or at most 10 percent, higher than the oxidation induction time of the same thermoplastic composition before having been subjected to the recycling process.

In one embodiment, the oxidation induction time of the thermoplastic composition, after having subjected the thermoplastic composition to a recycling process as described in the description, is at most 15 percent, or at most 10 percent, or at most 5 percent, lower than the oxidation induction time of the same thermoplastic composition before having been subjected to the recycling process.

In one embodiment, the oxidation induction time of the thermoplastic composition, after having subjected the thermoplastic composition nine times to the recycling process as described in the description, is at least 4 percent, or at least 6 percent, or at least 8 percent, higher than the oxidation induction time of the same thermoplastic composition before having been subjected to the recycling process. The increasing oxidation unit time is an indication of good thermal stability of the thermoplastic composition.

In one embodiment, the color of the thermoplastic composition is represented by an L value of at most 25, or at most 23, or at most 20, or at most 15, or at most 10. In one embodiment, the color of the thermoplastic composition is represented by an a value of at most 8, or at most 7, or at most 6, or at most 5, or at most 4.8, or at most 4.5, or at most 4.3. In one embodiment, the color of the thermoplastic composition is represented by a b value of at most 12, or at most 10, or at most 8, or at most 7, or at most 6.5, or at most 6.3 or at most 6.1.

In one embodiment, the color of the thermoplastic composition is represented by an L value of at least 2, or at least 4. In one embodiment, the color of the thermoplastic composition is represented by an a value of at least 1, or at least 2. In one embodiment, the color of the thermoplastic composition is represented by a b value of at least 4, or at least 6, or at least 8, or at least 10.

In one embodiment, the color 41 the of thermoplastic composition is represented by an L value of at most 25, or at most 23, or at most 20, or at most 15, or at most 10; and an a value of at most 8, or at most 7, or at most 6, or at most 5, or at most 4.8, or at most 4.5, or at most 4.3; and a b value of at most 12, or at most 10, or at most 8, or at most 7, or at most 6.5, or at most 6.3 or at most 6.1.

In one embodiment, the color of the thermoplastic composition is represented by an L value of at least 2, or at least 4; and the color of the thermoplastic composition is represented by an a value of at least 1, or at least 2; and the color of the thermoplastic composition is represented by a b value of at least 4, or at least 6, or at least 8, or at least 10.

The inventors surprisingly found out that the color of the thermoplastic composition is not essentially affected to a great extent by the fact that the thermoplastic composition is subjected to the recycling process.

In one embodiment, the L value, the a value, and/or the b value of the thermoplastic composition after having subjected the thermoplastic composition to a recycling process as described in the description, differs at most 15 percent, or at most 10 percent, or at most by 5 percent, from the L value, the a value and/or the b value of the same thermoplastic composition before having been subjected to the recycling process

In one embodiment, the L value of the thermoplastic composition after having subjected the thermoplastic composition to a recycling process as described in the description, differs at most 15 percent, or at most 10 percent, or at most by 5 percent, from the L value of the same thermoplastic composition before having been subjected to the recycling process.

In one embodiment, the L value of the thermoplastic composition, after having subjected the thermoplastic composition to a recycling process as described in the description, is at most 15 percent, or at most 10 percent, or at most 5 percent, higher or lower than the L value of the same thermoplastic composition before having been subjected to the recycling process.

In one embodiment, the L value of the thermoplastic composition, after having subjected the thermoplastic composition nine times to the recycling process as described in the description, differs at most by 15 percent, or at most by 10 percent, or at most by 5 percent, from the L value of the same thermoplastic composition before having been subjected to the recycling process.

In one embodiment, the L value of the thermoplastic composition, after having subjected the thermoplastic composition nine times to the recycling process as described in the description, is at most 15 percent, or at most 10 percent, or at most 5 percent, higher or lower than the L value of the same thermoplastic composition before having been subjected to the recycling process.

In one embodiment, the a value the thermoplastic composition after having subjected the thermoplastic composition to a recycling process as described in the description, differs at most 15 percent, or at most 10 percent, or at most by 5 percent, from the a value of the same thermoplastic composition before having been subjected to the recycling process.

In one embodiment, the a value of the thermoplastic composition, after having subjected the thermoplastic composition to a recycling process as described in the description, is at most 15 percent, or at most 10 percent, or at most 5 percent, higher or lower than the a value of the same thermoplastic composition before having been subjected to the recycling process.

In one embodiment, the a value of the thermoplastic composition, after having subjected the thermoplastic composition nine times to the recycling process as described in the description, differs at most by 15 percent, or at most by 10 percent, or at most by 5 percent, from the a value of the same thermoplastic composition before having been subjected to the recycling process.

In one embodiment, the a value of the thermoplastic composition, after having subjected the thermoplastic composition nine times to the recycling process as described in the description, is at most 15 percent, or at most 10 percent, or at most 5 percent, higher or lower than the a value of the same thermoplastic composition before having been subjected to the recycling process.

In one embodiment, the b value of the thermoplastic composition after having subjected the thermoplastic composition to a recycling process as described in the description, differs at most 15 percent, or at most 10 percent, or at most by 5 percent, from the b value of the same thermoplastic composition before having been subjected to the recycling process.

In one embodiment, the b value of the thermoplastic composition, after having subjected the thermoplastic composition to a recycling process as described in the description, is at most 15 percent, or at most 10 percent, or at most 5 percent, higher or lower than the b value of the same thermoplastic composition before having been subjected to the recycling process.

In one embodiment, the b value of the thermoplastic composition, after having subjected the thermoplastic composition nine times to the recycling process as described in the description, differs at most by 15 percent, or at most by 10 percent, or at most by 5 percent, from the b value of the same thermoplastic composition before having been subjected to the recycling process.

In one embodiment, the b value of the thermoplastic composition, after having subjected the thermoplastic composition nine times to the recycling process as described in the description, is at most 15 percent, or at most 10 percent, or at most 5 percent, same higher or lower than the value of the thermoplastic composition before having been subjected to the recycling process.

The L, a, and b values indicates values for the color of the recyclable thermoplastic composition. These values may be determined by DIN EN ISO 11664 and may be measured by any device, which allows measurement of the CIELab color space. The inventors of the current application surprisingly found out that the use of the lignin-based resulted in a “more” black colored thermoplastic composition than when using lignin that does not have the properties as defined in the current specification for the lignin-based filler. The recyclable thermoplastic composition has the added utility of having a color that does not essentially change when being subjected to the recycling process. Also it has the benefit, that no other colorants or pigments are needed to achieve the desired color of the composition and to maintain the color in recycling.

The thermoplastic composition as disclosed in the current specification has the added utility of showing a black color rather similar to that provided by carbon black. The thermoplastic composition as disclosed in the current specification has the added utility of showing good stability when compared to e.g. compositions prepared by using carbon black as the filler. Further, the thermoplastic composition has the added utility of being thermally stable. Further, the use of the lignin-based filler as described in the current specification has the added utility of making the thermoplastic composition recyclable as it allows sorting of the thermoplastic composition.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Testing Thermoplastic Compositions

In this example the purpose was to evaluate the performance of the lignin-based filler (LBF) in different thermoplastic compositions. In addition, comparative examples were prepared by using carbon black (CB) or pristine lignin (PL) in thermoplastic compositions instead of the lignin-based filler.

The lignin-based filler was prepared by following the description provided above in the current specification by using lignin material from enzymatic hydrolysis process of wood and subjected to hydrothermal carbonization treatment. The pristine lignin was lignin taken from the same enzymatic hydrolysis process of wood but that had not been subjected to the hydrothermal carbonization treatment. The carbon black used was MONARCH®800 provided by Cabot. Properties of the lignin-based filler, and the pristine lignin were measured and are presented in the below table 1:

TABLE 1

| | | | Lignin- | |
|---|---|---|---|---|
| Value | Measurement | | based | Pristine |
| measured | method | Unit | filler | lignin |
| STSA | ASTM D6556 | m²/g | 45.5 | 9.3 |
| Density | ISO 21687 | g/cm³ | 1.3-1.4 | 1.3-1.4 |
| C content | DIN 51732 | % | 65.93 | 60.3 |
| H content | DIN 51732 | % | 5.57 | 5.90 |
| N content | DIN 51732 | % | 0.11 | 0.76 |
| S content | DIN 51732 | % | 0.03 | <0.05 |
| Ash Content | DIN 51719 | % | 2.3 | 0.4 |
| Solubility | As described | % | 26.2 | 40.8 |
| 0.1M NaOH | in this | | | |
| | specification | | | |
| pH | ASTM D1512 | — | 8.4 | 6-7 |
| Moisture | ASTM D1509 | % | 0.7 | 2.4 |
| content | | | | |

The carbon content of the carbon black was >95% and the density was 1.8 g/cm³.

Firstly the following masterbatches were prepared:

TABLE 2

| Filler type | Polypropylene | Polystyrene |
|---|---|---|
| 40 weight-% | x | x |
| carbon black | | |
| 40 weight-% | x | x |
| pristine lignin | | |
| 40 weight-% | x | x |
| lignin-based | | |
| filler | | |

The masterbatches were prepared by combining components under the processing the following temperatures suitable for each polymer type: 40 weight-% of filler, 52 weight-% of the polymer, and in total 8 weight-% of an additive package (consisting of 2% of Ca-stearate (lubricant), 2% of Irganox 1010 antioxidant, 4% of polyethylene wax (lubricant)).

3 kg of each type of masterbatch was made, and this was done at a 40 weight-% filler-loading. The produced masterbatches were then physically dry blended at 3 weight-% and injection moulded to replicate the standard usage in injection moulding. The following combinations were injection moulded:
Polypropylene (PP) as a masterbatch in Polypropylene (PP) (indicated as PP thermoplastic composition below)
Polystyrene (PS) as a masterbatch in Acrylonitrile butadiene styrene (ABS) (indicated as ABS thermoplastic composition below)

The prepared thermoplastic compositions each contained 1.2 weight-% of the different fillers.

The samples were subjected to the recycling process as described in the current specification. In the below tables the “run 1” refers to the thermoplastic composition that has been extruded into a thermoplastic composition but has not been recycled. Run 5 indicates a composition that has been extruded into a thermoplastic composition and then subjected to the recycling process 4 times, and run 10 indicates a composition that has been extruded into a thermoplastic composition and then subjected to the recycling process 9 times.

The samples were analyzed and the results are presented in the below tables:

TABLE 3
Melt flow index of PP thermoplastic composition

| | MFI 230° C., 2.16 kg | | | MFI 230° C., 2.16 kg | | |
|---|---|---|---|---|---|---|
| | g/10 min | | | % | | |
| | | | Lignin- | | | Lignin- |
| | Carbon | Pristine | based | Carbon | Pristine | based |
| | black | lignin | filler | black | lignin | filler |
| Run 1 | 44.92 | 43.86 | 42.74 | 100 | 100 | 100 |
| Run 5 | 45.54 | 44.06 | 42.54 | 101 | 100 | 100 |
| Run 10 | 47.8 | 45.28 | 42.66 | 106 | 103 | 100 |

TABLE 4
Melt flow index of ABS thermoplastic composition

| | MFI 220° C., 10 kg | | | MFI 220° C., 10 kg | | |
|---|---|---|---|---|---|---|
| | g/10 min | | | % | | |
| | | | Lignin- | | | Lignin- |
| | Carbon | Pristine | based | Carbon | Pristine | based |
| | black | lignin | filler | black | lignin | filler |
| Run 1 | 30.32 | 31.69 | 32.82 | 100 | 100 | 100 |
| Run 5 | 31.88 | 34.38 | 34.51 | 105 | 108 | 105 |
| Run 10 | 33.78 | 36.03 | 36.54 | 111 | 114 | 111 |

As can be seen from tables 3 and 4, the values for the thermoplastic compositions made with lignin-based filler are more stable, when subjected to recycling, than when using pristine lignin. The values with lignin-based filler are the same as with using carbon black or even better.

TABLE 5
Oxidation induction time of PP thermoplastic composition

| | OIT | | | OIT | | |
|---|---|---|---|---|---|---|
| | min | | | % | | |
| | | | Lignin- | | | Lignin- |
| | Carbon | Pristine | based | Carbon | Pristine | based |
| | black | lignin | filler | black | lignin | filler |
| Run 1 | 65 | 57.3 | 63.8 | 100 | 100 | 100 |
| Run 5 | 61.9 | 57.7 | 67.7 | 95 | 101 | 106 |
| Run 10 | 57.8 | 58.,2 | 68.9 | 89 | 102 | 108 |

TABLE 6
Oxidation induction time of ABS thermoplastic composition

| | OIT | | | OIT | | |
|---|---|---|---|---|---|---|
| | min | | | % | | |
| | | | Lignin- | | | Lignin- |
| | Carbon | Pristine | based | Carbon | Pristine | based |
| | black | lignin | filler | black | lignin | filler |
| Run 1 | 32.4 | 39 | 28.9 | 100 | 100 | 100 |
| Run 5 | 26.2 | 34.5 | 28.2 | 81 | 88 | 98 |
| Run 10 | 25.5 | 31 | 28.7 | 79 | 79 | 99 |

As can be seen from tables 5 and 6, the values for the thermoplastic compositions made with lignin-based filler are better, when subjected to recycling, than when using pristine lignin. For PP thermoplastic composition, the oxidation induction time increased along the increasing rounds of recycling. For the ABS thermoplastic composition, the oxidation induction time did not essentially decrease as a result of being recycled. Both these results indicate that the thermoplastic composition has an excellent thermal stability.

TABLE 7
Color of the PP thermoplastic composition

| | | | | L value | | |
|---|---|---|---|---|---|---|
| | L value | | | % | | |
| | | | Lignin- | | | Lignin- |
| | Carbon | Pristine | based | Carbon | Pristine | based |
| | black | lignin | filler | black | lignin | filler |
| Run 1 | 6.38 | 20.09 | 13.94 | 100 | 100 | 100 |
| Run 5 | 5.51 | 17.99 | 13.37 | 86 | 90 | 96 |
| Run 10 | 4.98 | 17.61 | 13.35 | 78 | 88 | 96 |

TABLE 8
Color of the PP thermoplastic composition

| | | | | a value | | |
|---|---|---|---|---|---|---|
| | a value | | | % | | |
| | | | Lignin- | | | Lignin- |
| | Carbon | Pristine | based | Carbon | Pristine | based |
| | black | lignin | filler | black | lignin | filler |
| Run 1 | 0.23 | 9.55 | 4.73 | 100 | 100 | 100 |
| Run 5 | 0.28 | 8.86 | 4.61 | 122 | 93 | 97 |
| Run 10 | 0.33 | 8.72 | 4.68 | 143 | 91 | 99 |

TABLE 9
Color of the PP thermoplastic composition

| | | | | b value | | |
|---|---|---|---|---|---|---|
| | b value | | | % | | |
| | | | Lignin- | | | Lignin- |
| | Carbon | Pristine | based | Carbon | Pristine | based |
| | black | lignin | filler | black | lignin | filler |
| Run 1 | 1.2 | 13.47 | 6.99 | 100 | 100 | 100 |
| Run 5 | 0.75 | 11.89 | 6.66 | 63 | 88 | 95 |
| Run 10 | 0.75 | 11.74 | 6.7 | 63 | 87 | 96 |

TABLE 10
Color of the ABS thermoplastic composition

| | | | | L value | | |
|---|---|---|---|---|---|---|
| | L value | | | % | | |
| | | | Lignin- | | | Lignin- |
| | Carbon | Pristine | based | Carbon | Pristine | based |
| | black | lignin | filler | black | lignin | filler |
| Run 1 | 8.12 | 36.16 | 22 | 100 | 100 | 100 |
| Run 5 | 7.32 | 29.88 | 20.25 | 90 | 83 | 92 |
| Run 10 | 6.73 | 28.09 | 18.6 | 83 | 78 | 85 |

TABLE 11
Color of the ABS thermoplastic composition

| | | | | a value | | |
|---|---|---|---|---|---|---|
| | a value | | | % | | |
| | | | Lignin- | | | Lignin- |
| | Carbon | Pristine | based | Carbon | Pristine | based |
| | black | lignin | filler | black | lignin | filler |
| Run 1 | −0.5 | 5.47 | 4.22 | 100 | 100 | 100 |
| Run 5 | −0.4 | 5.26 | 4.03 | 80 | 96 | 95 |
| Run 10 | −0.24 | 5.11 | 4.23 | 48 | 93 | 100 |

TABLE 12
Color of the ABS thermoplastic composition

| | | | | b value | | |
|---|---|---|---|---|---|---|
| | b value | | | % | | |
| | | | Lignin- | | | Lignin- |
| | Carbon | Pristine | based | Carbon | Pristine | based |
| | black | lignin | filler | black | lignin | filler |
| Run 1 | −0.53 | 8.2 | 6.39 | 100 | 100 | 100 |
| Run 5 | −0.52 | 7.21 | 6.03 | 98 | 88 | 94 |
| Run 10 | −0.9 | 6.74 | 6.08 | 170 | 82 | 95 |

As can be concluded from tables 7-12, using lignin-based filler for producing a thermoplastic composition provides a more “black-resembling” color of the thermoplastic composition, especially when being subjected to the recycling, than when using pristine lignin.

### Example 2—Testing Thermoplastic Compositions

As in example 1, in this example the purpose was to evaluate the performance of the lignin-based filler (LBF) in thermoplastic compositions. In this example the following masterbatch was prepared:

TABLE 15

| Filler type | Polypropylene |
|---|---|
| 40 weight-% | x |
| lignin-based | |
| filler | |

The masterbatch thus contained: 40 weight-% of filler, 52 weight-% of the polymer, and in total 8 weight-% of an additive package (consisting of 2% of Ca-stearate (lubricant), 2 of Irganox 1010 antioxidant, 4% of polyethylene wax (lubricant)).

3 kg of the masterbatch was made, and this was done at a 40 weight-% filling. The produced masterbatch was then physically dry blended with polypropylene at 3 weight-%, 5 weight-%, or 10 weight-%, and injection moulded to replicate the standard usage in injection moulding. The following combination was injection moulded:
Polypropylene (PP) as a masterbatch in Polypropylene (PP) (indicated as PP thermoplastic composition below)

The prepared thermoplastic compositions each contained 1.2 weight-%, 2 weight-%, or 4 weight-% of lignin-based filler.

TABLE 16
Color of PP thermoplastic composition
(measured with BYK spectro-guide)

| | Color measurement | | |
|---|---|---|---|
| Amount of filler | L | a | b |
| 1.2 weight-% | 12.93 | 4.67 | 6.58 |
| lignin-based | | | |
| filler | | | |
| 2 weight-% lignin- | 9.77 | 4.43 | 5.72 |
| based filler | | | |
| 4 weight-% lignin- | 8.28 | 4 | 4.94 |
| based filler | | | |

The results show that with increasing the amount of lignin-based filler in the thermoplastic composition, the color of the thermoplastic composition becomes darker.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A thermoplastic composition, the use, or a method, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A recyclable thermoplastic composition made by using at least one polymer and a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%, and wherein:
the color of the thermoplastic composition is represented by an L value of at most 25, an a value of at most 8, and a b value of at most 12 as determined by DIN EN ISO 11664.

2. The recyclable thermoplastic composition of claim 1, wherein the thermoplastic composition contains 0.1-65 weight-% of the lignin-based filler based on the total weight of the thermoplastic composition.

3. The recyclable thermoplastic composition of claim 1, wherein the melt flow index of the thermoplastic composition, after having subjected the thermoplastic composition to a recycling process as described in the description differs at most by 15 percent from the melt flow index of the same thermoplastic composition before having been subjected to the recycling process.

4. The recyclable thermoplastic composition of claim 1, wherein oxidation induction time of the thermoplastic composition, after having subjected the thermoplastic composition to the recycling process as described in the description, differs at most by 15 percent from the oxidation induction time of the same thermoplastic composition before having been subjected to the recycling process.

5. The recyclable thermoplastic composition of claim 1, wherein the melt flow index of the thermoplastic composition, after having subjected the thermoplastic composition nine times to the recycling process as described in the description, differs at most by 15 percent from the melt flow index of the same thermoplastic composition before having been subjected to the recycling process.

6. The recyclable thermoplastic composition of claim 1, wherein the L value, the a value, and/or the b value of the thermoplastic composition after having subjected the thermoplastic composition to a recycling process as described in the description, differs at most 15 percent from the L value, the a value and/or the b value of the same thermoplastic composition before having been subjected to the recycling process.

7. The recyclable thermoplastic composition of claim 1, wherein the starting material for the lignin-based filler is lignin derived from an enzymatic hydrolysis process and/or from a Kraft process.

8. The recyclable thermoplastic composition of claim 1, wherein the lignin-based filler comprises ash in a total amount of 0.1-2.5 weight-%.

9. The recyclable thermoplastic composition of claim 1, wherein the solubility of the lignin-based filler in 0.1 M NaOH is 1-40 weight-%.

10. The recyclable thermoplastic composition of claim 1, wherein the lignin-based filler has a weight average molecular weight of 1000-4000 Da when determined based on the soluble fraction of the lignin-based filler.

11. The recyclable thermoplastic composition of claim 1, wherein the polydispersity index of the lignin-based filler is 1.5-5.0 when determined based on the soluble fraction of the lignin-based filler.

12. Use of a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most by 3 weight-%, for producing a recyclable thermoplastic composition by using at least one polymer and the lignin-based filler, wherein:
the color of the thermoplastic composition is represented by an L value of at most 25, an a value of at most 8, and a b value of at most 12 as determined by DIN EN ISO 11664.

13. The use of claim 12, wherein the thermoplastic composition contains 0.1-65 weight-% of the lignin-based filler based on the total weight of the thermoplastic composition.

14. The use of claim 12, wherein the melt flow index of the thermoplastic composition, after having subjected the thermoplastic composition to a recycling process as described in the description, differs at most by 15 percent from the melt flow index of the same thermoplastic composition before having been subjected to the recycling process.

15. The use of claim 12, wherein the melt flow index of the thermoplastic composition, after having subjected the thermoplastic composition nine times to the recycling process as described in the description, differs at most by 15 percent from the melt flow index of the same thermoplastic composition before having been subjected to the recycling process.

16. The use of claim 12, wherein the oxidation induction time of the thermoplastic composition, after having subjected the thermoplastic composition to a recycling process as described in the description, differs at most by 15 percent from the oxidation induction time of the same thermoplastic composition before having been subjected to the recycling process.

17. The use of claim 12, wherein the L value, the a value, and/or the b value of the thermoplastic composition after having subjected the thermoplastic composition to a recycling process as described in the description, differs at most 15 percent from the L value, the a value and/or the b value of the same thermoplastic composition before having been subjected to the recycling process.

18. The use of claim 12, wherein the lignin-based filler is formed from lignin derived from an enzymatic hydrolysis process and/or from a Kraft process.

19. The use of claim 12, wherein the lignin-based filler comprises ash in a total amount of 0.1-2.5 weight-%.

20. The use of claim 12, wherein the solubility of the lignin-based filler in 0.1 M NaOH is 1-40 weight-%.

21. The use of claim 12, wherein the lignin-based filler has a weight average molecular weight of 1000-4000 Da when determined based on the soluble fraction of the lignin-based filler.

22. The use of claim 12, wherein the polydispersity index of the lignin-based filler is 1.5-5.0 when determined based on the soluble fraction of the lignin-based filler.

23. A method for producing a recyclable thermoplastic composition comprising at least one polymer and a lignin-based filler, wherein the method comprises:
providing at least one polymer and a lignin-based filler, wherein the lignin-based filler is prepared from lignin subjected to hydrothermal carbonization treatment, and wherein the lignin-based filler comprises carbon in a total amount of 62-70 weight-% and ash in a total amount of at most 3 weight-%; and
combining the at least one polymer and the lignin-based filler to form the recyclable thermoplastic composition, wherein the color of the thermoplastic composition is represented by an L value of at most 25, an a value of at most 8, and a b value of at most 12 as determined by DIN EN ISO 11664.

24. The method of claim 23, wherein the thermoplastic composition contains 0.1-65 weight-% of the lignin-based filler based on the total weight of the thermoplastic composition.

25. The method of claim 23, wherein combining the at least one polymer and the lignin-based filler comprises preparing a masterbatch and then compounding the masterbatch with the at least one polymer.

26. The method of claim 23, wherein combining the at least one polymer and the lignin-based filler comprises directly compounding the polymer and the lignin-based filler.

27. The method of claim 23, wherein the step of combining the at least one polymer and the lignin-based filler comprises also combining one or more additives, lubricants, stabilizers, and/or antioxidants to form the recyclable thermoplastic composition.

28. An article comprising the recyclable thermoplastic composition of claim 1.

29. The article of claim 28, wherein thermoplastic composition has been shaped into the article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

30. The use of the thermoplastic composition of claim 1 in a packaging, a housing, an automotive part, an aviation part, a marine part, a machine part, a sports equipment, a sports equipment part, a leisure equipment, a leisure equipment part, a tool, a part of a tool, a pipe, a membrane, a tube, a fitting, a bottle, a film, a bag, a sack, a textile, a rope, a container, a tank, an electrical component, an electronic component, a part for energy generation, a toy, an appliance, a kitchenware, a tableware, a flooring, a fabric, a medical application, a food contact material, a construction material, a drinking water application, and/or a furniture.
